(19) United States
(12) Patent Application Publication
(10) Pub. No.: US 2016/0261086 A1
(43) Pub. Date: Sep. 8, 2016

(54) TUNABLE LIGHT MODULATION USING GRAPHENE

(71) Applicant: CORNING INCORPORATED, CORNING, NY (US)

(72) Inventors: Valerio Pruneri, Castelldefels (ES); Renwen Yu, Castelldefels (ES); Francisco Javier Garcia de Abajo, Madrid (ES)

(21) Appl. No.: 15/057,532

(22) Filed: Mar. 1, 2016

Related U.S. Application Data
(60) Provisional application No. 62/128,800, filed on Mar. 5, 2015.

(51) Int. Cl. H01S 3/106

(52) U.S. Cl. CPC H01S 3/1062; H01S 3/106

(57) ABSTRACT

Described herein are optical devices based on two-dimensional materials and methods for making such devices. In particular, the articles described herein are useful in the control and modulation of light via graphene mono- or multilayers. methods for improved transfer of graphene from formation substrates to target substrates. The improved articles provide exceedingly high modulation depths in vis-NIR light transmission, with small insertion losses, thus revealing the potential of graphene for fast electro-optics within such a technologically important range of optical frequencies.

This application claims the benefit of priority under 35 U.S.C. §119 of U.S. Provisional Application Ser. No. 61/128800 filed on Mar. 5, 2015 the content of which is relied upon and incorporated herein by reference in its entirety.

### FIELD

Described herein are optical devices based on two dimensional materials and methods for making such devices. In particular, the articles described herein are useful in the control and modulation of light via graphene mono- or multilayers.

### TECHNICAL BACKGROUND

Graphene is a two-dimensional monolayer of sp²-bonded carbon atoms that has been attracting great interest following its experimental isolation by the mechanical cleavage of graphite. Its unique physical properties, such as high intrinsic carrier mobility (˜200,000 cm²/Vs), quantum electronic transport, tunable band gap, high mechanical strength and elasticity, and superior thermal conductivity, make graphene promising for many applications, including high speed transistors, energy/thermal management, and optoelectronics. In addition, study and understanding of its structure has led to the development of other ultrathin and monolayer materials that show promise. As the current generation of silicon-based devices reach their fundamental minimum size limit in the coming years, ultrathin materials will provide an opportunity to design even smaller devices.

### SUMMARY

A first aspect comprises an optical modulating device comprising (a) a resonating optical structure in which the light intensity of an optical beam is amplified, and (b) an ultrathin layer inside or in proximity of the aforesaid resonating structure operating in the linear optical regime, whereby the modulation of the light transmitted, reflected or generated by the resonating structure is achieved by applying an electrical voltage, E_{F}, or mechanical displacement to the ultrathin layer. In some embodiments, the mechanical displacement of the ultrathin layer is achieved using piezoelectric or capacitive force effects.

In some embodiments, the ultrathin layer is any absorbing or refracting material with a thickness smaller than the operating optical wavelength. In some embodiments, the ultrathin layer has a thickness less than 20 nm, less than 15 nm, less than 10 nm, or less than 5 nm. In some embodiments, the ultrathin layer comprises a layer that is 10 or less atoms or molecules thick. In some embodiments, the ultrathin layer comprises a monolayer or a series of one or more monolayers, wherein the one or more monolayers may not be in direct contact with each other. In some embodiments, the ultrathin layer comprises graphene, a hexagonal boron nitride, a transition metal dichalcogenide, a group IV or group III metal chalcogenide, a silicene, a germanene, a binary group III-V compound, or a binary group IV compound. In some embodiments, the ultrathin layer is one or more layers of a material whose absorption or index of refraction can be controlled by applying a voltage.

Another aspect comprises any of the optical modulating devices above, wherein the resonating optical structure comprises a Fabry-Perot interferometer.

Another aspect comprises any of the optical modulating devices above, wherein the resonating optical structure comprises a tunneling resonant structure made of multilayer dielectrics incorporating the ultrathin layer. In some embodiments, the tunneling resonant structure operates under frustrated total internal reflection.

Another aspect comprises any of the optical modulating devices above, wherein the device further comprises metallic nanoparticles forming a layer adjacent to and approximately parallel to the ultrathin layer, the metallic nanoparticles having a diameter 2R, an average nanoparticle center-to-center distance of P, and an average distance from the ultrathin layer of d. In some embodiments, 2R is from about 100 nm to about 3.0 μm, P is from about 500 nm to about 1500 nm, and d is from about 100 nm to about 3.0 μm. In some embodiments, the metallic nanoparticles are ordered in a trigonal, square, hexagonal, or close-packed arrangement.

Another aspect comprises any of the optical modulating devices above, wherein the device further comprises dielectric nanoparticles forming a layer adjacent to and approximately parallel to the ultrathin layer, the metallic nanoparticles having a diameter 2R, an average nanoparticle center-to-center distance of P, and an average distance from the ultrathin layer of d. In some embodiments, 2R is from about 100 nm to about 3.0 μm, P is from about 500 nm to about 1500 nm, and d is from about 100 nm to about 3.0 μm. In some embodiments, the metallic nanoparticles are ordered in a trigonal, square, hexagonal, or close-packed arrangement.

In some embodiments of any of the above aspects, the resonating optical structure may further comprise a laser gain medium. In such embodiments, the modulation from the ultrathin layer allows for tuning the laser to above or below the threshold to produce an output modulated laser signal. In some embodiments, the modulation from the ultrathin layer actively mode-locks the modes of the laser to generate an output mode-locked train of optical pulses.

In some embodiments of any of the above aspects, the modulation of the light transmitted, reflected or generated by the resonating structure is induced by change of external parameters. In such embodiments, the external parameter comprises a mechanical displacement or pressure force, or alternatively, the external parameter comprises an electrical signal.

In some embodiments of any of the above aspects, E_{F} is from about 0.1 eV to about 2.0 eV. In some embodiments of any of the above aspects, the resonant wavelength is in a region from about 400 nm to about 1.4 mm.

Additional features and advantages will be set forth in the detailed description which follows, and in part will be readily apparent to those skilled in the art from the description or recognized by practicing the embodiments as described in the written description and claims hereof, as well as in the appended drawings.

It is to be understood that both the foregoing general description and the following detailed description are merely exemplary, and are intended to provide an overview or framework for understanding.

### BRIEF DESCRIPTION OF THE DRAWINGS

The accompanying drawings are included to provide a further understanding, and are incorporated in and constitute a part of this specification.

FIGS. 1A-1F describe an embodied graphene optical switch based on resonant tunneling transmission. FIG. 1A compares the doping-induced absorption switching effect for undoped graphene (upper scheme, Fermi level at the Dirac point), which can absorb photons (vertical arrow) over a broad spectral range via interband electron transitions, and doped graphene (lower scheme), in which Pauli exclusion blocks photon absorption when the Fermi energy EF exceeds half the photon energy; FIG. 1B is an embodiment (not to scale) comprising a planar multilayer structure for the resonant tunneling transmission of light, including a central BN planar waveguide and two single-layer graphene films intercalated at the BN/SiO₂ interfaces; FIG. 1C shows the potentials in for FIG. 1B in the equivalent Schrodinger model; FIG. 1C shows the electric field intensity normalized to the external light intensity for an incidence angle of 71° and a free-space wavelength of 689 nm. Light is s (TE) polarized and incident from the left. Results for different levels of doping are offered (see FIG. 1E). FIG. 1E is the transmission spectra of the multilayer structure at 71° incidence for different levels of doping. The transmission maxima are in agreement with the analytical expression offered herein (see arrows). The numerical labels correspond to the ratio Re{σ}/(e2/4h) evaluated at a wavelength of 689 nm. FIG. 1F is a graphic of the transmission as a function of incidence angle and wavelength for doped and undoped graphene.

FIGS. 2A-2C describe an alternative embodiment of a graphene optical switch based on resonant tunneling transmission. In this embodiment, the structure only comprises one graphene layer (FIG. 2A). As can be seen in FIGS. 2B and 2C, the resulting transmittance and reflectance values are similar to that seen in the two-layer graphene system of FIG. 1A.

FIGS. 3A-3C describe an alternative embodiment of a graphene optical switch based on resonant tunneling transmission. In this embodiment, the structure only comprises one graphene layer (FIG. 3A), similar to that seen in FIG. 2A, but now the second outcoupling medium, previously labeled as BF11, has been removed.

FIGS. 4A-4C describe an embodied graphene optical switch based on resonant Fabry-Perot transmission. FIG. 4A shows an embodied Fabry-Perot resonator incorporating a tunable graphene layer inside the cavity flanked by two Bragg mirrors. FIGS. 4B and 4C provide spectral of the normal incidence transmittance (FIG. 4B) and reflectance (FIG. 4C) for different levels of doping. In the embodied example, the cavity is filled with air, but similar performance is achieved with a narrower, glass-filled cavity.

FIGS. 5A-5C described an alternative embodied graphene optical switch based on resonant Fabry-Perot transmission. FIG. 5A shows a Fabry-Perot cavity similar to that of FIG. 4A, but filled with glass and designed to operate in the same spectral region using modified geometrical parameters. FIGS. 5B and 5C provide spectral of the normal incidence transmittance (FIG. 5B) and reflectance (FIG. 5C) for different levels of doping

FIG. 6 describes the electric field intensity enhancement relative to the incident intensity inside the Fabry-Perot cavity considered in FIG. 4A, calculated at the 738 nm resonance wavelength in the absence of graphene. The addition of a second graphene layer at an antinode (rightmost graphene layer in this plot) produces exactly the same transmission and reflection spectra as in FIGS. 4B and 4C, regardless the doping state of the extra layer. The width of the cavity is 800 nm and other geometrical parameters are the same as in FIG. 4A.

FIGS. 7A-7B describe graphene absorption enhancement by coupling to Mie resonances. FIG. 7A shows the absorption cross section normalized to the projected sphere area (πR²), estimated for the silicon-sphere/undoped-graphene system shown in the inset using Eq. (1) and Mie theory. We plot the increase in absorption due to the presence of the sphere. The silicon/graphene separation is d=R/150. The upper scale corresponds to a sphere radius R=300 nm and d=2 nm. The incident electric field is along the x direction. FIG. 7B plots the parallel electric-field intensity enhancement (|Eₓ|²+|E_{y}|²)/|E₀|² at the graphene plane for the two Mie resonances labeled A and B in FIG. 7A. The quality factors Q of these resonances are also indicated in FIG. 7A.

FIGS. 8A-8C describe embodiments comprising graphene decorated with a 2D array of Mie resonators for tunable absorption. FIG. 8A shows a side view of the geometry and parameters of a triangular array of silicon spheres near graphene. FIG. 8B is a spectrum of the normal-incidence transmission through the sphere array without graphene for different lattice periods P. The wavelength is shown both normalized to the sphere radius R (lower scale) and for R=300 nm (upper scale). FIG. 8C is an spectrum of the absorbance of the array when it is placed near undoped graphene (silicon-carbon distance d=R/150) under normal incidence. The lattice period is P=800 nm.

FIGS. 9A-9C describes an alternative embodiment of graphene decorated with a 2D array of Mie resonators, shown as a window in FIG. 9A, wherein FIG. 9A further shows the normal-incidence (k_{∥}=0) absorption spectra for a triangular lattice of silicon spheres (radius R=300 nm and lattice period P=800 nm) placed on top of a graphene sheet (silicon-carbon separation distance d=2 nm) when the graphene is supported on a silica substrate. FIG. 9B is the same as FIG. 9A, but for a square lattice. FIG. 9C shows a dispersion diagram of the triangular silicon-sphere lattice without graphene in the Mie resonance region under consideration. The white vertical segment in FIG. 9C indicates the spectral range in FIG. 9A, dominated by a sphere Mie mode that is crossed by a lattice resonances at finite k_{∥}. The lattice resonance produces a narrowing of the Mie mode.

FIGS. 10A-10E describe an embodiment wherein graphene absorption is tunably enhanced by coupling to lattice resonances in 2D metal particle arrays. FIG. 10A described an embodiment wherein a square array of gold spheres (radius R) is placed above graphene (2 nm gold-to-carbon separation). The entire system is assumed to be embedded in silica (ε=2.25). FIGS. 10B and 10C show the normal-incidence transmission FIG. 10B and reflection FIG. 10C spectra for R=80 nm and different lattice periods P with either doped (broken curves, E_{F}=1 eV) or undoped (solid curves) graphene. The spectra are dominated by lattice resonances occurring near a free-space light wavelength λ˜P√ε. FIG. 10D charts the peak wavelength with doped graphene (right scale) and transmission at that wavelength with either doped or undoped graphene (left scale) as a function of gold sphere radius for a period P=500 nm. Similarly, FIG. 10E charts the peak wavelength for silver particles.

### DETAILED DESCRIPTION

Before the present materials, articles, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps. Where comprise, or variations thereof, appears the terms “consists essentially of” or “consists of” may be substituted.

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

“Optional” or “optionally” means that the subsequently described event or circumstance can or cannot occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As noted above, graphene is a promising material in optoelectronics due to the extraordinary optoelectronic properties derived from its peculiar band structure of massless charge carriers. Notably, its optical absorption can be switched on/off via electrical doping. In its undoped state, it absorbs a fraction πα≈2.3% of the incident light over a broad spectral range within the visible to near infrared electromagnetic spectrum (“vis-NIR”) as a result of direct electron-hole pair transitions between its lower occupied Dirac cones and the upper unoccupied cones (two inequivalent ones in every Brillouin zone). In contrast, when electrically doped, an optical gap is opened that suppresses vertical optical transitions for photon energies below 2|E_{F}|, where E_{F} is the change in Fermi energy relative to the undoped state. In practice, values of E_{F} as high as 1 eV can be obtained through electrical gating, therefore enabling the modulation of light absorption down to the visible regime. Chemical methods permit achieving even higher levels of doping, which could be combined with additional electrostatically induced variations of E_{F} around a high bias point to reach control over shorter light wavelengths.

Fast light modulation at vis-NIR frequencies can find application in optical signal processing and interconnect switching, where there is a great demand for integrated wavelength-sized devices capable of operating at terahertz commutation rates. The extraordinary electrooptical response of graphene provides a key ingredient for the realization of these types of devices. However, the exploitation of atomically thin carbon films for light modulation faces the problem of their relatively weak interaction with light. A possible solution to enhance this interaction is to use the intrinsic plasmons that show up in the optical gap of this material when it is highly doped. Resonant coupling to graphene plasmons can even result in complete optical absorption, as exemplified by the observation of large tunable light modulation at mid-IR frequencies in periodically nanostructured graphene. The extension of this strategy down to the vis-NIR spectral domain remains a challenge, as it requires to laterally pattern the carbon film with <10 nm features, which are currently unattainable through conventional lithographies, although chemical self-assembly might offer a viable way of producing the required structures.

An alternative solution consists in amplifying the absorption of undoped graphene either by increasing the region over which light interacts with it or by coupling the carbon film to an optical cavity of high quality factor (i.e., by trapping light during long times near the graphene). A broadband modulator has been demonstrated with the former approach by exposing a long path of an optical waveguide to electrically gated graphene. Additionally, coupling to photonic cavities has been explored using plasmonic structures, photonic-crystals, and metamaterials. For example, monolayer graphene integrated with metallic metasurfaces has been used to control the optical response (resonance position, depth, and linewidth) at mid-IR frequencies. Similarly, large intensity modulations (>30%) of mid-IR light over a 600 nm bandwidth have been reported in graphene-loaded plasmonic antennas. Additionally, a resonance wavelength shift ˜2 nm accompanied by a 4-fold variation in reflectivity has been observed in the NIR by coupling graphene to a photonic crystal cavity. Enhanced visible light absorption in graphene has also been demonstrated (without modulation) by combining monolayer graphene with metamaterials, gold nanovoid arrays, and photonic waveguides, as well as by coupling multilayer graphene under total internal reflection.

Aspects described herein provide novel modulation schemes employing planar, ultrathin layers of materials (e.g., graphene or graphene-like materials) in a resonant cavity to modulate optical signals that traverse the layer in a generally perpendicular manner. Combining resonant optical structures with the ultrathin layer in a proper manner can provide intriguing functionalities. For example, the ultrathin layer can be engineered at the position where large intensity enhancement, provided by the resonant optical structure, is present. It can lead to tremendous modification of optical properties (e.g., transmission and/or reflection) of the whole system when the ultrathin layer can be tuned in different embodiments.

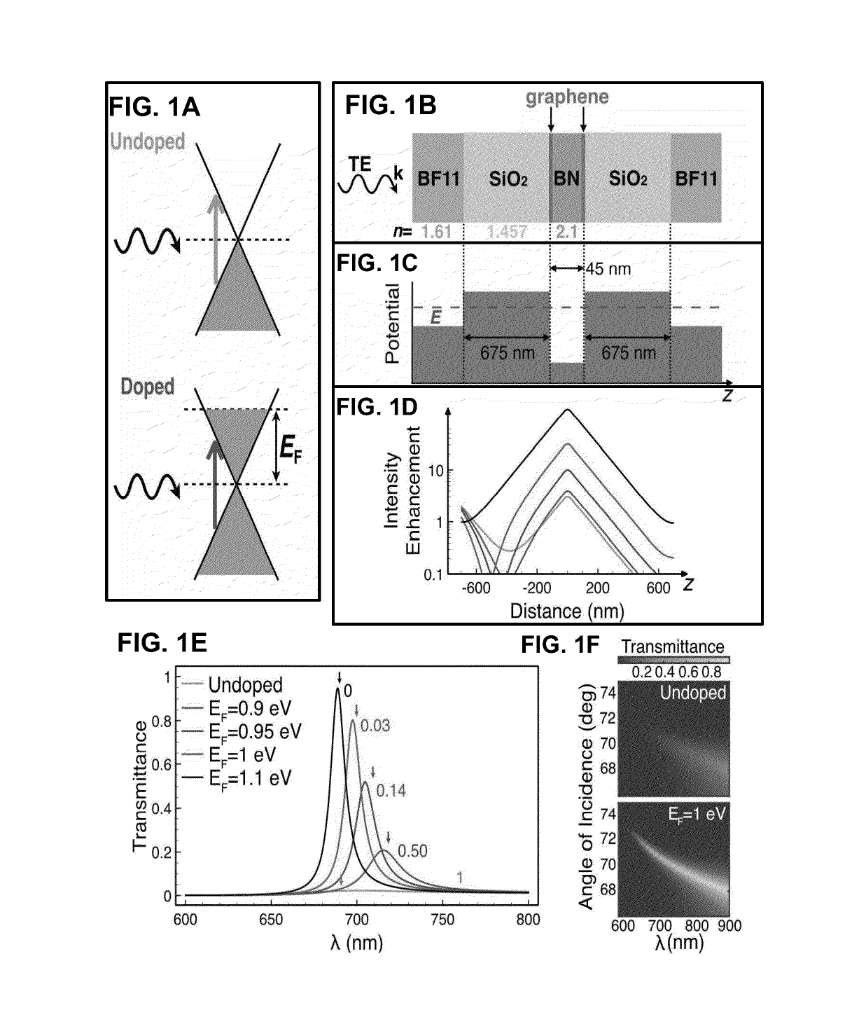

Modulation can be achieved through any number of methods including, for example, by applying a voltage to the ultrathin layer (electrical gating) or by mechanically changing the ultrathin layer position with respect to the light intensity pattern within the cavity. The application of the voltage signal through Pauli blocking effects and/or mechanical displacement produces a significant change in reflection and transmission of the cavity incorporating the ultrathin layer. In some embodiments, the ultrathin layer comprises a doping-induced absorption switching effect, as shown in FIG. 1A, where undoped graphene can absorb photons (vertical arrow) over a broad spectral range via interband electron transitions (upper scheme, Fermi level=Dirac point), and doped graphene where Pauli exclusion rules block photon absorption when the Fermi energy, E_{F}, exceeds half the photon energy (lower scheme). In some embodiments for the aspect described herein, the ultrathin material is doped, E_{F}, to a value of from about 0.1 to about 2.0 eV, about 0.1 to about 1.5 eV, about 0.1 to about 1.4 eV, about 0.1 to about 1.3 eV, about 0.1 to about 1.2 eV, about 0.1 to about 1.1 eV, about 0.1 to about 1.0 eV, about 0.1 to about 0.9 eV, about 0.1 to about 0.8 eV, about 0.1 to about 0.7 eV, about 0.3 to about 2.0 eV, about 0.3 to about 1.5 eV, about 0.3 to about 1.4 eV, about 0.3 to about 1.3 eV, about 0.3 to about 1.2 eV, about 0.3 to about 1.1 eV, about 0.3 to about 1.1 eV, about 0.3 to about 0.9 eV, about 0.3 to about 0.8 eV, about 0.3 to about 0.7 eV, about 0.2 to about 2.0 eV, about 0.5 to about 1.5 eV, about 0.5 to about 1.4 eV, about 0.5 to about 1.3 eV, about 0.5 to about 1.2 eV, about 0.5 to about 1.1 eV, about 0.5 to about 1.1 eV, about 0.5 to about 0.9 eV, about 0.5 to about 0.8 eV, about 0.5 to about 0.7 eV, about 0.8 to about 2.0 eV, about 0.8 to about 1.5 eV, about 0.8 to about 1.4 eV, about 0.8 to about 1.3 eV, about 0.8 to about 1.2 eV, about 0.8 to about 1.1 eV, about 0.8 to about 1.1 eV, or about 0.8 to about 0.9 eV.

Advantageously, the articles described herein do not need to be structured and can be used in a planar geometry, are designed to be utilized such that the light has a large interaction with the ultrathin layer, are easily fabricated and integrated into current waveguide, fiber and communications designs, and could be readily applied to other commercial electronics devices, such as displays, OLEDs, and handheld electronic devices.

A first aspect comprises an optical modulating device comprising a resonant optical structure in combination with an ultrathin layer of one or more materials, wherein the ultrathin layer is inside the resonating structure. In some embodiments, the resonant optical structure comprises an optical cavity or optical waveguide. In some embodiments, the resonant output of the structure is linear. In some embodiments, modulation of the light is achieved by applying an acoustic, mechanical, magnetic, optical, or electrical force or potential to the ultrathin layer. In particular, modulation may be controlled by electric potential or mechanical displacement of the ultrathin layer.

Resonant optical structures may comprise any optical cavity, resonator or other device that amplifies or modulates the light intensity from an incident beam. Examples include, but are not limited to, standing wave cavity resonators, interferometers, optical parametric oscillators, Fabry-Perot cavities and interferometers, and waveguides, such as optical fibers, and crystals.

The ultrathin layer can comprise one or more very thin layers of materials. Generally, the ultrathin layer is designed to have a thickness less than the operating optical wavelength. In some embodiments, the ultrathin layer is less than 20 nm, less than 15 nm, less than 10 nm, or less than 5 nm thick. In some embodiments, the ultrathin layer comprises a layer that is 10 or less atoms or molecules thick. In some embodiments, the ultrathin layer comprises a layer that is 5 or less atoms or molecules thick. In some embodiments, the ultrathin layer is a monolayer or a series of monolayers. The ultrathin layer may be elemental or may be a compound. For example, the ultrathin layer may comprise carbon, silicon, or boron nitride. In some embodiments, the ultrathin layer comprises graphene or a graphene-like material, such as hexagonal boron nitride, transition metal dichalcogenides, group IV or group III metal chalcogenides, silicene, germanene, binary group III-V compounds, or binary group IV compounds (see, e.g., 113 CHEM. REV. 3766 (2013), herein incorporated by reference). The composition of the ultrathin layer may further comprise dopants, or other atoms or components not normally found in the structure, but inserted in low amounts to affect the properties of the material. In some embodiments, dopants may include transition metals, group III elements, other group IV elements, and group V elements, such as nitrogen. As used herein, where the term “graphene” is used, it is assumed that other graphene-like materials or ultrathin layers can be substituted to provide similar or like behavior, unless specifically or inherently excluded.

A second aspect comprises an optical switch comprising an ultrathin layer-containing resonant tunneling structure. Generically, the optical switch comprises an input, at least one ultrathin input modulator, a resonant tunneling structure, an optional output modulator, and an output. An embodiment of this aspect is shown via the concept of resonant switching and modulation of graphene absorption by coupling to a high-quality-factor planar cavity. In particular, consider the multi-layer structure depicted in FIG. 1B, comprising a high-refractive-index boron nitride (BN) planar waveguide (n_{BN}=2.1) flanked by two sheets of graphene and then two low-index silica spacers (n_{SiO2}=1.457), and an incoupling and outcoupling medium (both BF11). The waveguide hosts guided modes that can be resonantly coupled to light of well-defined parallel wave vector (i.e., for a collimated incident beam). In our case, light is incident from the left under total internal reflection conditions at the BF11-SiO₂ interface (n_{BF11}=1.61). The evanescent spill out of light intensity penetrating inside the left silica spacer can reach the BN waveguide, where it is amplified to further extend towards the rightmost interface. In the absence of absorption, full transmission can always be achieved at a resonant wavelength that depends on incidence angle.

The ultrathin layer embodied in FIG. 1B is graphene, but could be a graphene-like material, such as hexagonal boron nitride, transition metal dichalcogenides, group IV or group III metal chalcogenides, silicene, germanene, binary group III-V compounds, or binary group IV compounds or other ultrathin material as described herein. Similarly, while boron nitride is used as the high refractive index planar waveguide, any other suitable materials with the correct refractive index and properties could be substituted to produce a similar, or alternative, resonant tunneling structure. The input comprises the optical components necessary to input light into the optical switch and may comprise materials and components known in the art. Similarly, the output comprises the optical components necessary to output light from the optical switch and may comprise materials and components known in the art. The other components of the device may be similarly substituted with materials known to one of skill in the art based on the necessary properties. Further, additional components, such as coatings, optics, or filters, may be added or removed as necessary to optimize the device characteristics.

Again, considering FIG. 1B, there is complete analogy between TE light propagation in the planar structure under consideration and the evolution of an electron according to the Schrödinger equation. The equivalent electron has energy E and evolves along a potential profile as shown in FIG. 1C. The latter is directly related to the refractive index, with higher index corresponding to lower values of the potential. The presence of a bound state is always guaranteed in a 1D cavity, and so is the existence of a full transmission resonance when this bound state lies inside the potential barrier. Under complete-transmission conditions, the intensity has to decay exponentially from the waveguide to the far medium (i.e., along the rightmost silica barrier), to reach the same value as the incident intensity, so that the near field has to be strongly amplified at the central waveguide. This type of enhancement, which is clearly illustrated in FIG. 1D, is used to amplify the effect of absorption taking place at the graphene. Experimental corroboration in quantum dot fluorescence has shown a >100-fold increase in the output for quantum dots placed in resonance near the central waveguide.

The embodiment shown in FIG. 1B comprises a graphene film on either side of the central BN waveguide. Besides its high index of refraction, the choice of BN for the central waveguide is convenient because this combination of materials is compatible with high-quality graphene. However, the high index BN material can generally be replaced by other high index material layers known in the art and that are able to work in a structure suitable for resonant tunneling. In some instances, for example in models describing the conductivity σ, the graphene mobility is assumed to be μ=2000 cm²/(Vs). In embodiments where the graphene layer is highly doped (E_{F}=1.1 eV), it becomes nearly lossless (i.e., small Re{σ}) at the waveguide resonance wavelength, so that the peak transmission reaches 95% (FIG. 1E), while the extinction ratio (i.e., the ratio of transmission in doped to undoped states) is >15 dB, and the light intensity enhancement at the waveguide exceeds a factor of 140. In contrast, in the undoped state, the carbon layer become lossy (i.e., nearly real σ≈e²/4h), so the enhancement is strongly suppressed, and the transmission drops to very small values. The transmission can be actually tuned continuously between these two extreme values by varying the level of doping (see FIG. 1E). As noted above, the ultrathin material can be doped over a large range of E_{F}. In particular, it can be advantageous in some embodiments—particularly with optionally modified graphene—to have an EF value of from about 0.8 to about 1.5 eV, about 0.8 to about 1.4 eV, about 0.8 to about 1.3 eV, about 0.8 to about 1.2 eV, about 0.8 to about 1.1 eV, or about 0.8 to about 1.1 eV.

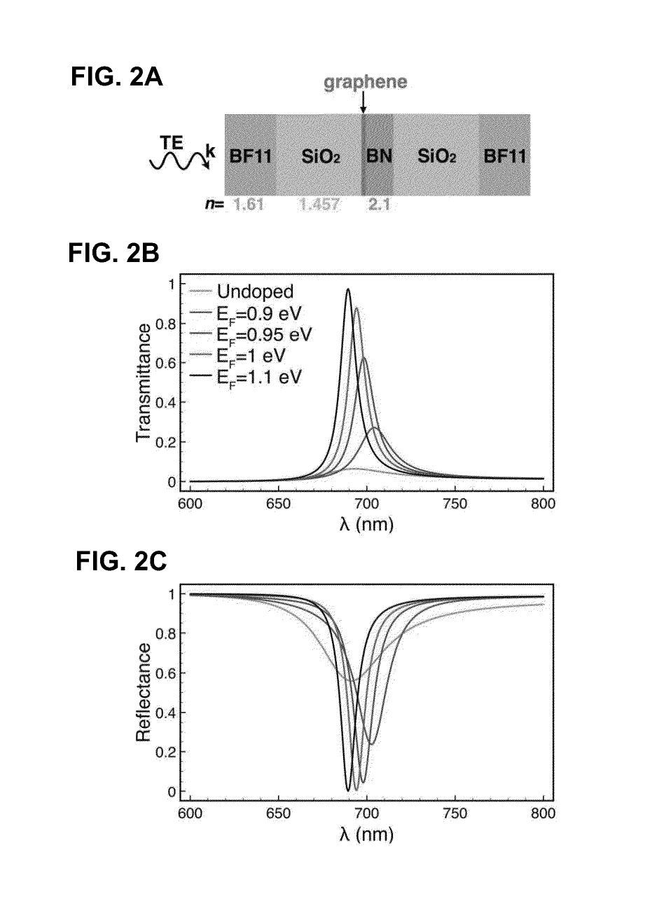

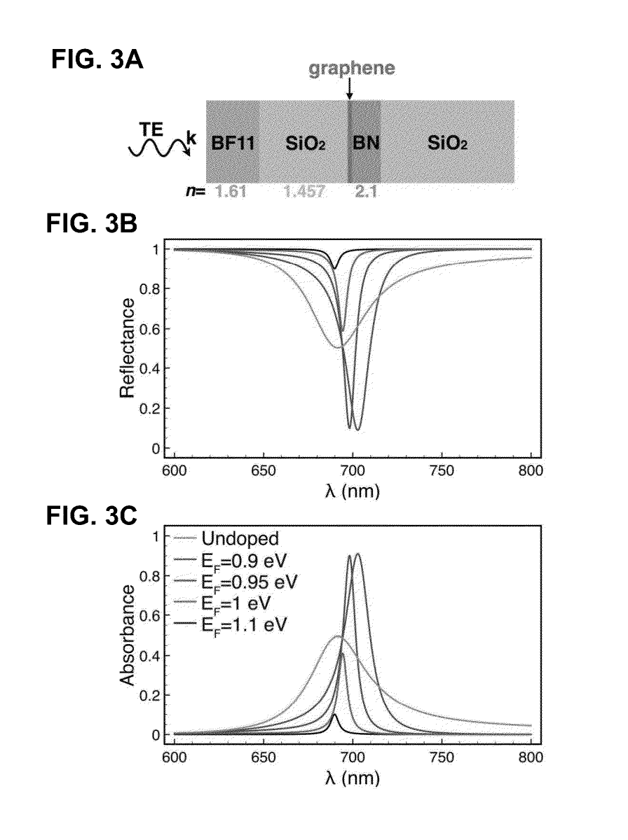

Without wanting to be held to any particular theory, the decrease in transmission produced when moving from highly doped to undoped graphene is due to both absorption and reflection, as the local change in the response of the carbon layer produces a departure from the conditions of resonant tunneling. In fact, in some embodiments, reflection accounts for the bulk of the depletion in transmission, e.g., from about 20% to about 95%, about 30% to about 90%, about 40% to about 90%, about 50% to about 90%, about 60% to about 90%, about 50% to about 80%, about 60% to about 80% of the transmission loss. In such embodiments, the fact that reflection is the primary driver can be exploited to simplify the structure. For example, FIG. 2A provides an alternative embodiment wherein the a single layer of graphene is provided on the front face of the BN planar waveguide. As shown in FIGS. 2B and 2C, the device continues to provide excellent modulation properties. In another embodiment, shown in FIG. 3A, the device is further simplified by removal of the rightmost outcoupling medium, BF11. As shown in FIGS. 3B and 3C, the device still undergoes unity-order modulation of the reflection upon graphene doping.

The wavelength of operation of this modulator is essentially determined by the waveguide mode. In some embodiments, the resonance wavelength, λᵣₑₛ can be generally described by the equation:

$${λ}_{res} = \frac{- 2 π {k}_{z 2} d}{k {ϕ}^{2}} ( ϕ + \frac{8 π ( k / c ) cos ( ϕ / 2 ) Im \{ σ \}}{\sqrt{{\vert {k}_{z 1} \vert}^{2} + {\vert {k}_{z 2} \vert}^{2}}} )$$

where d is the waveguide thickness, k is the wave vector in air, Im{σ} is the surface conductivity of graphene, φ is the reflection phase at the silica/BN interface, k_{z1} and k_{z2} are the wave vectors along the light propagation direction in silica and BN, respectively. Values from these analytical calculations are indicated by downwards arrows in FIG. 1E, in excellent agreement with the observed transmission maxima. Coupling to the BF11 media shown in the embodiments is understandably only producing a slight shift—hence, the reflection minimum is observed to be only mildly modified when the rightmost glass is removed. The resonance wavelength also depends on the angle of incidence and it can be pushed down to the visible regime (FIG. 1F), although the maximum transmission decreases towards smaller wavelengths due to the gradual involvement of interband transitions in the graphene. In some embodiments, the resonance wavelength is from about 400 nm to about 3 μm, about 400 nm to about 1.4 μm, about 400 nm to about 1.0 μm, about 400 nm to about 750 nm, about 750 nm to about 3 μm, about 750 nm to about 1.4 μm, about 750 nm to about 1.0 μm, about 1.0 μm to about 3 μm, about 1.4 μm to about 3 μm, about 1.0 μm to about 3 μm.

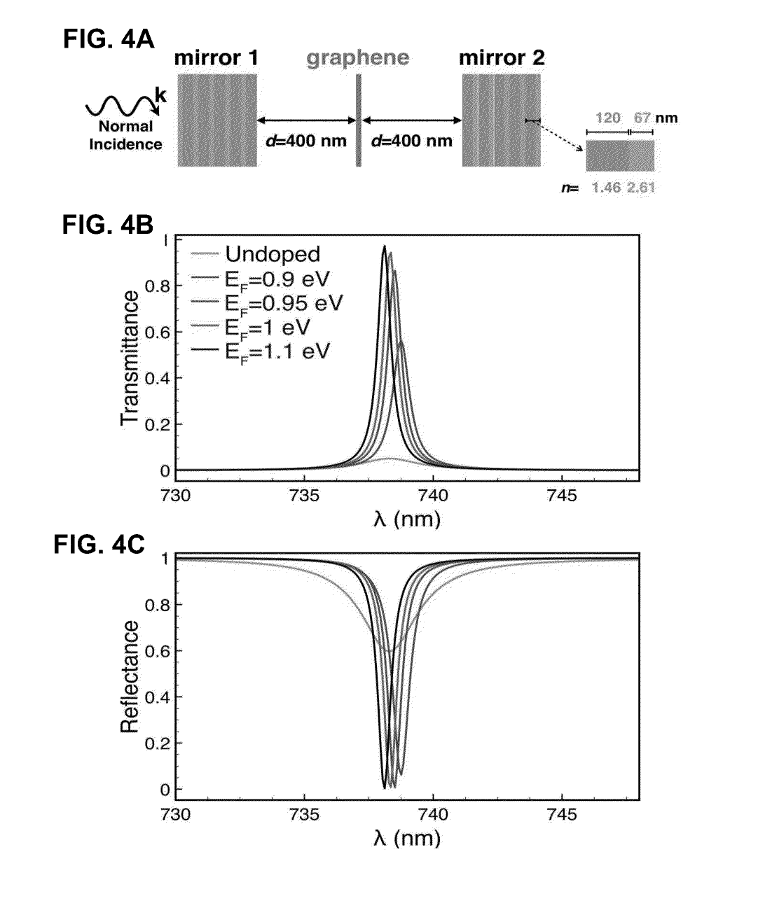

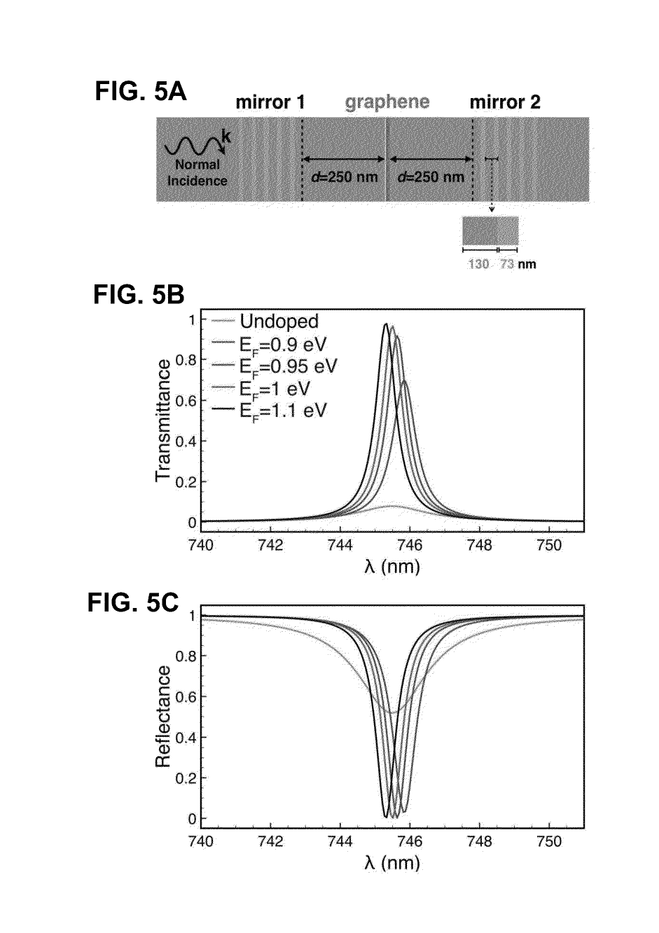

A third aspect comprises an optical switch comprising a ultrathin layer-containing Fabry-Perot resonator. The concept of the tunneling structure in FIG. 1B can be extrapolated to other types of resonators in which the incident field also undergoes a large enhancement at a position decorated with the ultrathin layer (in this case, graphene). A particularly convenient implementation of this idea is presented in FIG. 4A, as it allows operating under normal incidence conditions. More precisely, we replace the tunneling structure by a Fabry-Perot (FP) frequency-selective filter, comprising a cavity flanked by two non-absorbing, nearly perfectly reflecting mirrors. In some embodiments, Bragg mirrors such as those shown in FIG. 4A would be used and which are easy to fabricate by multilayer deposition, however alternative mirrors known in the art may also be used. In some embodiments, the separation between the FP mirrors is chosen to produce a single resonant transmission peak. In the embodied example, the resonant transmission peak has been chosen to be in the 730-750 nm spectral region (FIG. 4B), but the wavelength selection can be chosen as necessary. In some embodiments, the resonance wavelength is from about 400 nm to about 3 μm, about 400 nm to about 1.4 μm, about 400 nm to about 1.0 μm, about 400 nm to about 750 nm, about 750 nm to about 3 μm, about 750 nm to about 1.4 μm, about 750 nm to about 1.0 μm, about 1.0 μm to about 3 μm, about 1.4 μm to about 3 μm, about 1.0 μm to about 3 μm. As can be seen in FIG. 4C, reflectance can play a big role in at least some of the embodied structures. At resonance, light is trapped inside the cavity, so it makes many passes through it before escaping, thus generating a large field enhancement at several interference nodes. We place the graphene at one of those nodes. Interplay between absorption (imaginary part of the susceptibility) and polarization (real part) in the graphene leads to large (but not totally complementary) modulations in reflection and transmission, similar to those discussed above for the tunneling device. Similar performance is obtained by filling the cavity with glass and reducing its size, thus configuring a more robust structure, as shown in the embodiment in FIG. 5A and spectral results in FIGS. 5B-5C. In some embodiments, the cavity can be further reduced to produce a 1D crystal that exhibits a normal incidence gap, in which a localized optical mode exist due to the cavity. In such embodiments, the graphene couples to the localized mode to produce a compact light modulator.

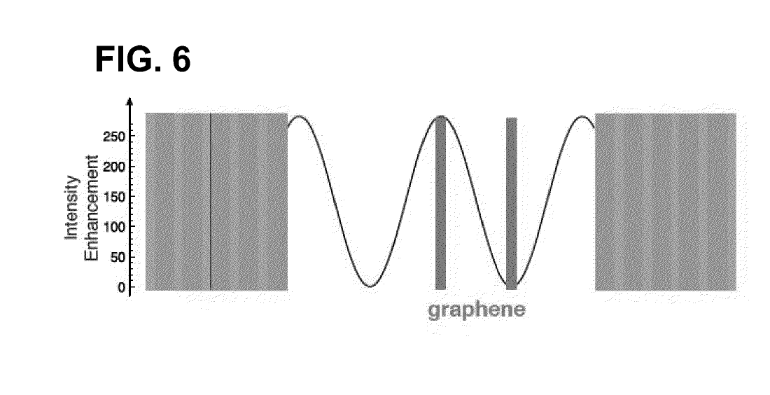

In some embodiments, the cavity is unaffected if an ultrathin layer (e.g., graphene) is placed at an antinode of the interference standing wave inside the cavity, as shown in FIG. 6. In some embodiments, the ultrathin layer-containing Fabry-Perot resonator further comprises a second, optically-inactive, ultrathin layer located at an antinode that serves as a gate with which to dope the other ultrathin layer placed at a node. In other embodiments, ultrathin layer-containing Fabry-Perot resonator further comprises an optically-inactive ultrathin layer that is capable of being moved between nodes and/or antinodes to produce or affect the intensity pattern inside the cavity.

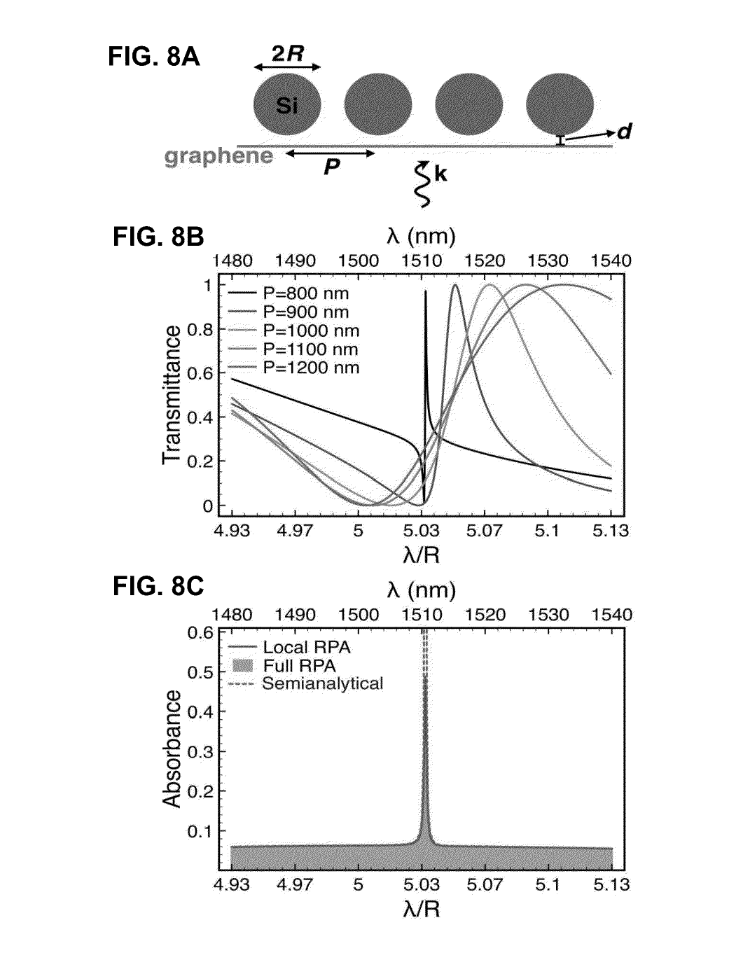

A fourth aspect comprises an optical device comprising a Mie cavity-coupled graphene device. Looking at example embodiment FIG. 8A, the Mie cavity-coupled device comprises a ultrathin layer with one or more nanoscale particles of diameter 2R in close proximity to the ultrathin layer (separated from the ultrathin layer by a length, d), and spaced apart from each other by a center-to-center distance of P. The diameter 2R is from about 100 nm to about 3.0 μm, about 150 nm to about 1.4 μm, about 400 nm to about 1.4 μm, about 400 nm to about 750 nm, about 750 nm to about 1.4 μm, or about 1000 nm to about 1.4 μm. The spacing distance P can be from about 500 nm to about 1500 nm, about 600 nm to about 1400 nm, about 700 nm to about 1300 nm, or about 800 nm to about 1200 nm. Finally, the separation distance, d, is from about 100 nm to about 3.0 μm, about 100 nm to about 1.0 μm, about 200 nm to about 1.0 μm, about 200 nm to about 700 nm, about 200 nm to about 500 nm, or about 100 nm to about 500 nm. The nanoparticles may be laid out in any number of structures, include ordered array or lattice-type structures, random, or a combination thereof. In some embodiments, the nanoparticles are in a trigonal, square, hexagonal, or close-packed arrangement.

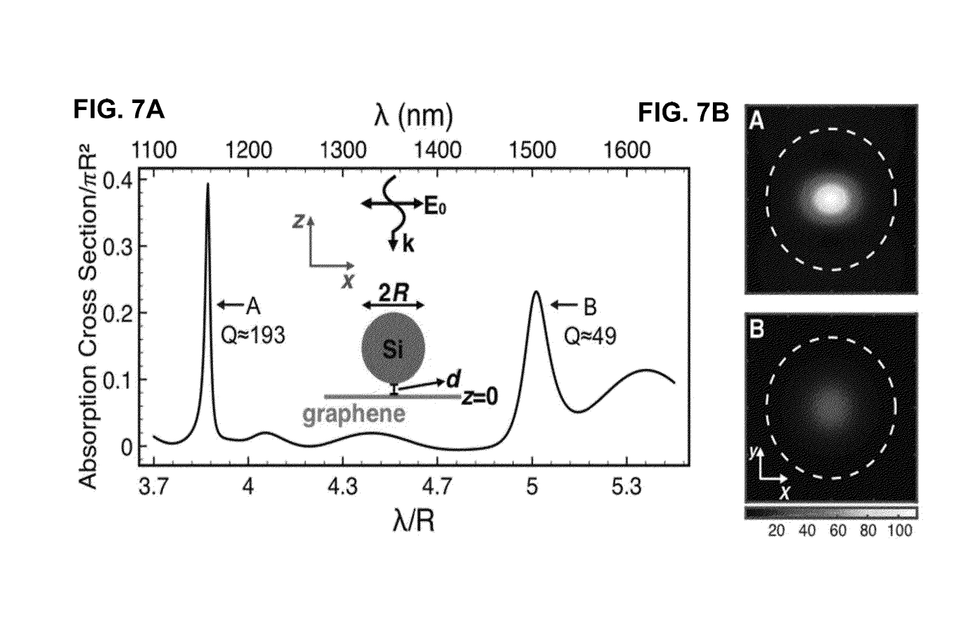

FIG. 7A represents the change in the absorption cross section undergone by a layer of undoped graphene when we place a silicon sphere (ε=12) in its vicinity. These types of silicon colloids have been recently synthesized and used as excellent photonic cavities. The increase in absorption cross section δσ^{abs} remains a small fraction of the extinction produced by the sphere in this configuration (e.g., 6.1% and 2.7% for the Mie modes labeled A and B in FIG. 7A), so we approximate it as:

δσ^{abs}≈πα∫dxdy|E_{∥}/Eₒ|²,

where E_{∥} is the parallel component of the electric field scattered by the sphere alone, E₀ is the incident field, and we integrate over the graphene plane. The field E_{∥} is obtained from Mie theory. This approximate method yields similar results as the change in elastic (dark-field) scattering due to doping, calculated from a rigorous modal expansion for the sphere-graphene system. In FIG. 7B the cross section is normalized to the projected area of the sphere πR² and the wavelength is normalized to the sphere radius R, so that this plot is independent of R, apart from the relatively small variations of the permittivity of silicon over the NIR. Despite the subwavelength size of the particle, its high ε allows it to trap light within Mie modes of high quality factor (Q≈193 and 49 in modes A and B, FIG. 7A), giving rise to large local enhancements of the near-field intensity at the plane of the graphene (FIG. 7B). This in turn boosts the absorption, which takes remarkably large values, with a peak increase in cross section reaching ˜40% of the projected area of the sphere. The spatial distribution of absorption (proportional to the intensity plotted in FIG. 7B) is strongly confined to the near-contact region, which could be exploited for engineering the spatial distribution of optically induced heat deposition, as well as for controlling the graphene electron-gas ultrafast dynamics before relaxation and thermalization of the absorbed energy takes place.

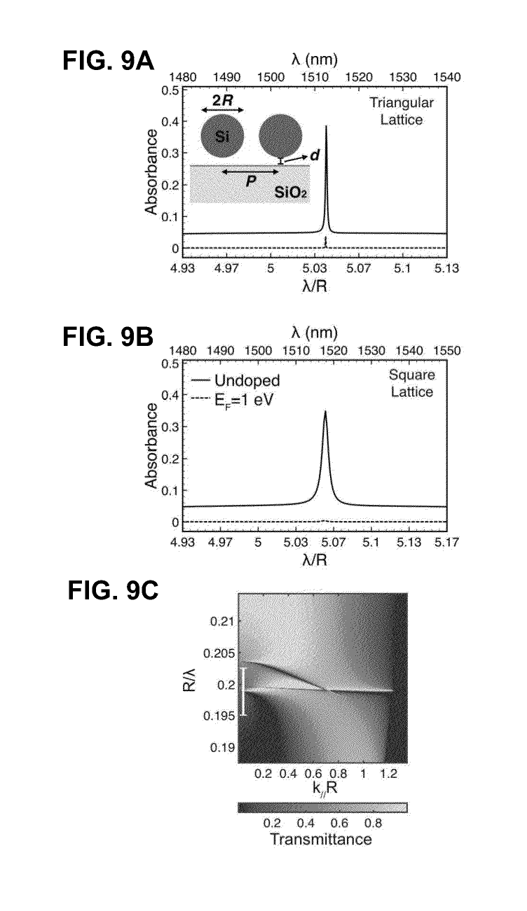

Because the maximum value of δσ^{abs} produced by a single silicon sphere is comparable to its projected area, we expect to obtain unity-order changes in the absorption when the graphene is decorated by a periodic array. This is illustrated in FIGS. 8A-8C, where we concentrate on the spectral region around the rightmost Mie mode of FIG. 7A (labeled “B”). We consider the silicon spheres to be arranged in a triangular lattice, which we simulate using a layer-KKR approach (see 132 COMPUT. PHYS. COMMUN. 189 (2000), herein incorporated by reference). There is strong interaction between the particles for the lattice spacing, P, under consideration, which can be intuitively quantified from the fact that the extinction cross section of the sphere equals the area of a circle of diameter about 1.75 μm. The transmission of the particle array experiences dramatic spectral variations as P is changed, eventually generating a narrow transmission peak, which is relatively close, but not on top of the lowest-order Wood anomaly, occurring when the wavelength is equal to the period at normal incidence; we thus attribute this feature to the interaction between Mie modes of the spheres, as the wavelength is close (but not right on) a lattice resonance that narrows the resulting spectral feature (FIG. 9A). A similar mechanism leading to sharp, narrow asymmetric resonances has already been described in the context of cavity- waveguide coupling. The absorbance associated with this narrow peak is boosted, approaching 50% with undoped graphene (FIG. 8C), whereas doped graphene shows comparatively negligible absorbance.

A fifth aspect comprises an optical device comprising an ultrathin layer resonantly coupled to strong scattering lattice. We now discuss the absorption enhancement produced by lattice resonances, for which strong scatterers such as metallic particles are preferable.

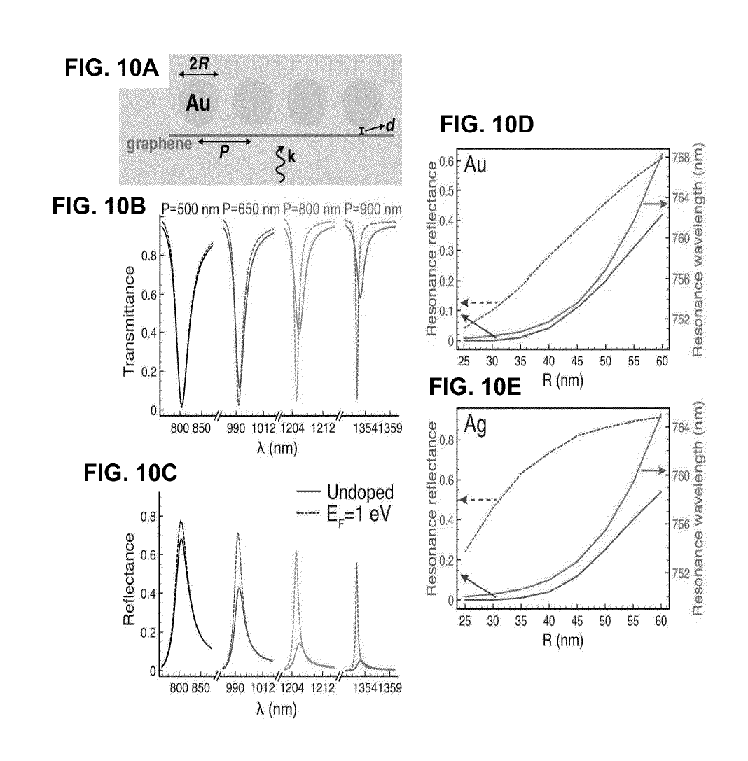

Although metals introduce additional losses, their absorbance is relatively small in the NIR, so graphene can still make a big difference. This is corroborated by the embodiment in FIG. 10A, where we consider a ultrathin layer decorated with a 2D square array of gold spheres surrounded by silica for different values of the lattice spacing P. Further expanding on this aspect, the strong scattering lattice-coupled device comprises a ultrathin layer with one or more strong scattering nanoscale particles of diameter 2R in close proximity to the ultrathin layer (separated from the ultrathin layer by a length, d), and spaced apart from each other by a center-to-center distance of P. In these embodiments, the diameter 2R is from about 100 nm to about 3.0 μm, about 150 nm to about 1.4 μm, about 400 nm to about 1.4 μm, about 400 nm to about 750 nm, about 750 nm to about 1.4 μm, or about 1000 nm to about 1.4 μm. The spacing distance P can be from about 500 nm to about 1500 nm, about 600 nm to about 1400 nm, about 700 nm to about 1300 nm, or about 800 nm to about 1200 nm. Finally, the separation distance, d, is from about 100 nm to about 3.0 μm, about 100 nm to about 1.0 μm, about 200 nm to about 1.0 μm, about 200 nm to about 700 nm, about 200 nm to about 500 nm, or about 100 nm to about 500 nm. The nanoparticles may be laid out in any number of structures, include ordered array or lattice-type structures, random, or a combination thereof. In some embodiments, the nanoparticles are in a trigonal, square, hexagonal, or close-packed arrangement.

The transmission (FIG. 10B) and reflection (FIG. 10C) spectra of these structures exhibit sharp features emerging near the Wood anomaly condition (i.e., when the wavelength in the surrounding dielectric is close to the period, or equivalently, when a diffraction order becomes grazing), which can be easily understood in terms of lattice resonances. As the period is increased, these features move to the red, where the metal is less lossy, and consequentially, the resonances become narrower. The additional absorption produced by the undoped graphene then becomes more noticeable, eventually causing a decrease in peak transmittance of ˜60%, accompanied by a 28-fold reduction in reflectance.

The mechanisms here considered for light modulation by graphene can be integrated in devices spanning only a few square microns in size, so they require a relatively small amount of doping charge to operate. We thus anticipate that these systems will be able to modulate vis-NIR light at high speeds with a minute consumption of power, typical of capacitive devices. This is an advantage with respect to alternative commutation devices based on quantum-wells and phase-change materials.

### EXAMPLES

The following examples are put forth so as to provide those of ordinary skill in the art with a complete disclosure and description of how the materials, articles, and methods described and claimed herein are made and evaluated, and are intended to be purely exemplary and are not intended to limit the scope. Efforts have been made to ensure accuracy with respect to numbers (e.g., amounts, temperature, etc.) but some errors and deviations should be accounted for. Only reasonable and routine experimentation will be required to optimize such process conditions.

### Example 1

A device of the design shown in FIG. 1B comprises two graphene layers and a BN waveguide, wherein doping of the graphene layers is done via transparent electrodes. The graphene layers are biased with a relative potential difference V, so that they reach a Fermi energy |E_{F}|=hv_{F}\sqrt{Vε_{BN}/4d_{BN}}, where v_{F}≈10⁶ m/s is the Fermi velocity in the carbon layer, while ε_{BN} and d_{BN} are the static permittivity and thickness of the BN layer. For d_{BN}˜45 nm, a value of E_{F}=1 eV is obtained with potentials ˜4 V.

### Example 2

In an integrated commutation device operating over an area A=50×50 μm² (i.e., covering a customary optical beam size), with an estimated capacitance C=Aε/4πd˜0.3 pF, where we consider ε=4 (DC silica) and a gate separation d=300 nm (d can be chosen as needed). The time response is then limited by the sheet resistance of the graphene layer (˜100 Ω/s), giving an overall cutoff frequency for the electrical bandwidth of ½πRC˜5 GHz, while the optical limit for the electrical modulation of the photonic response (i.e., the effect related to the decay time of the resonance) renders a larger cutoff (c/2LQ˜150 GHz for a cavity length L˜1 μm and a quality factor Q˜10³). The large electrooptical response of graphene combined with its small volume are thus ideal attributes for the design of fast optical modulators and switches operating in the vis-NIR, which can benefit from the coupling to optical resonators such as those explored in the present work. In particular, the planar structures presented in FIG. 1B and FIG. 4A, which rely on unstructured graphene, provide relatively affordable designs that are appealing for micro integration and mass production.

Although the embodiments herein have been described with reference to particular aspects and features, it is to be understood that these embodiments are merely illustrative of desired principles and applications. It is therefore to be understood that numerous modifications may be made to the illustrative embodiments and that other arrangements may be devised without departing from the spirit and scope of the appended claims.

What is claimed is:

1. An optical modulating device comprising:
(a) a resonating optical structure in which the light intensity of an optical beam is amplified; and
(b) an ultrathin layer inside or in proximity of the aforesaid resonating structure operating in the linear optical regime, whereby the modulation of the light transmitted, reflected or generated by the resonating structure is achieved by applying an electrical voltage, E_{F}, or mechanical displacement to the ultrathin layer.

2. The optical modulating device of claim 1, wherein the ultrathin layer comprises any absorbing or refracting material with a thickness smaller than the operating optical wavelength.

3. The optical modulating device of claim 1, wherein the ultrathin layer has a thickness less than 20 nm.

4. The optical modulating device of claim 3, wherein the ultrathin layer comprises a layer that is 10 or less atoms or molecules thick.

5. The optical modulating device of claim 4, wherein the ultrathin layer comprises a monolayer or a series of one or more monolayers, wherein the one or more monolayers may not be in direct contact with each other.

6. The optical modulating device of claim 5, wherein the ultrathin layer comprises graphene, a hexagonal boron nitride, a transition metal dichalcogenide, a group IV or group III metal chalcogenide, a silicene, a germanene, a binary group III-V compound, or a binary group IV compound.

7. The optical modulating device of claim 1, wherein the ultrathin layer comprises one or more layers of a material whose absorption or index of refraction can be controlled by applying a voltage.

8. The optical modulating device of claim 1, wherein the mechanical displacement of the ultrathin layer is achieved using piezoelectric or capacitive force effects.

9. The optical modulating device of claim 1, wherein the resonating optical structure comprises a Fabry-Perot interferometer.

10. The optical modulating device of claim 1, wherein the resonating optical structure comprises a tunneling resonant structure made of multilayer dielectrics incorporating the ultrathin layer.

11. The optical modulating device of claim 10, wherein the tunneling resonant structure operates under frustrated total internal reflection.

12. The optical modulating device of claim 1, wherein the device further comprises metallic nanoparticles forming a layer adjacent to and approximately parallel to the ultrathin layer, the metallic nanoparticles having a diameter 2R, an average nanoparticle center-to-center distance of P, and an average distance from the ultrathin layer of d.

13. The optical modulating device of claim 12, wherein 2R is from about 100 nm to about 3.0 μm, P is from about 500 nm to about 1500 nm, and d is from about100 nm to about 3.0 μm.

14. The optical modulating device of claim 1, wherein the device further comprises dielectric nanoparticles forming a layer adjacent to and approximately parallel to the ultrathin layer, the metallic nanoparticles having a diameter 2R, an average nanoparticle center-to-center distance of P, and an average distance from the ultrathin layer of d.

15. The optical modulating device of claim 14, wherein 2R is from about 100 nm to about 3.0 μm, P is from about 500 nm to about 1500 nm, and d is from about 100 nm to about 3.0 μm.

16. The optical modulating device of claim 1, wherein the resonating optical structure further comprises a laser gain medium.

17. The optical modulating device of claim 16, wherein the modulation from the ultrathin layer allows for tuning the laser to above or below the threshold to produce an output modulated laser signal.

18. The optical modulating device of claim 1, wherein the modulation of the light transmitted, reflected or generated by the resonating structure is induced by change of external parameters.

19. The optical modulating device of claim 1, wherein E_{F} is from about 0.1 eV to about 2.0 eV.

20. The optical modulating device of claim 1, wherein the resonant wavelength is in a region from about 400 nm to about 1.4 μm.
